(19) United States
(12) Patent Application Publication
(10) Pub. No.: US 2026/0227918 A1
(43) Pub. Date: Aug. 6, 2026

(54) PER-RANK POWER MANAGEMENT OPERATIONS FOR A MULTI-RANK MEMORY SYSTEM

(71) Applicant: Micron Technology, Inc., Boise, ID (US)

(72) Inventor: Antonino CAPRI', Bergamo (IT)

(21) Appl. No.: 19/437,140

(22) Filed: Dec. 30, 2025

Related U.S. Application Data
(60) Provisional application No. 63/752,219, filed on Jan. 31, 2025.

(51) Int. Cl. G06F 3/06

(52) U.S. Cl. CPC G06F 3/0625; G06F 3/0655

(57) ABSTRACT

In some implementations, a memory controller may determine that an idle timer for a rank of a memory channel satisfies a first threshold. The memory controller may transition, based on determining that the idle timer for the rank satisfies the first threshold, the rank from a first power state to a second, lower power state, wherein at least one other rank of the memory channel is maintained in the first power state. The memory controller may determine that an activation trigger has occurred, wherein the activation trigger includes at least one of: determining, by the memory controller, that a reduced-power timer satisfies a second threshold, or receiving, by the memory controller, a command associated with the rank. The memory controller may transition the rank from the second power state to the first power state in response to determining that the activation trigger has occurred.

### CROSS-REFERENCE TO RELATED APPLICATION

This Patent Application claims priority to U.S. Provisional Patent Application No. 63/752,219, filed on Jan. 31, 2025, entitled “PER-RANK POWER MANAGEMENT OPERATIONS FOR A MULTI-RANK MEMORY SYSTEM,” and assigned to the assignee hereof. The disclosure of the prior Application is considered part of and is incorporated by reference into this Patent Application.

### TECHNICAL FIELD

The present disclosure generally relates to power management operations for memory systems and, for example, per-rank power management operations for a multi-rank memory system.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some aspects, a memory device may be associated with a multi-rank memory system, such as a double data rate (DDR) memory system, a low-power double data rate (LPDDR) memory system, and/or a similar memory system.

### BRIEF DESCRIPTION OF THE DRAWINGS

FIG. 1 is a diagram illustrating an example system capable of per-rank power management operations.

FIG. 2 is a diagram illustrating an example of a multi-rank memory system capable of per-rank power management operations.

FIG. 3 is a diagram illustrating an example associated with power state switching for a multi-rank memory system.

FIG. 4 is a diagram illustrating an example associated with per-rank power management operations for a multi-rank memory system.

FIG. 5 is a diagram illustrating an example associated with refresh mode switching for a multi-rank memory system.

FIG. 6 is a diagram illustrating another example associated with per-rank power management operations for a multi-rank memory system.

FIG. 7 is a diagram illustrating another example associated with per-rank power management operations for a multi-rank memory system.

FIG. 8 is a diagram illustrating another example associated with per-rank power management operations for a multi-rank memory system.

FIG. 9 is a diagram illustrating another example associated with per-rank power management operations for a multi-rank memory system.

FIG. 10 is a flowchart of an example method associated with per-rank power management operations for a multi-rank memory system.

### DETAILED DESCRIPTION

The increasing demand for low-power memory in applications requiring large capacities, such as terabyte-scale systems for artificial intelligence, has driven the need to optimize power consumption to reduce operational costs. LPDDR memory offers the potential for power savings by utilizing internal reduced power states during periods of inactivity. The management of these power states is typically the responsibility of the memory controller, which may also handle the standard commands associated with LPDDR memory.

A prevailing approach to power management in memory controllers is to monitor activity at the granularity of a memory channel, which may consist of multiple memory devices and/or ranks. When the memory controller detects inactivity for a given channel, the memory controller may put the entire channel into a low-power state to save energy. In some examples, putting an entire memory channel into a low-power state fails to take advantage of opportunities to selectively shut down individual portions of a channel, such as a single rank, based on workload variations and address mapping. This lack of selectivity may lead to suboptimal power savings and/or may not fully exploit the available features of LPDDR memory to minimize power use. Furthermore, a refresh mechanism implemented by traditional memory controllers, which may be used for maintaining data integrity, may not offer the flexibility to dynamically switch between different refresh modes (such as per-bank refresh or all-bank refresh) once the initial mode is set at power-up. This limitation may also lead to missed opportunities for additional power savings during periods when the memory is not actively being accessed.

Some implementations described herein enable more granular and dynamic low power management within multi-rank memory architectures (e.g., multi-rank LPDDR memory architectures), such as power management operations that enable a memory controller to manage power states and refresh mechanisms more intelligently and flexibly, with the aim of achieving greater power efficiency in multi-rank memory architectures. For example, a memory controller may determine that an idle timer for a specific rank of a memory channel satisfies a first threshold, and thus may transition that rank from a first power state to a second (lower) power state, while maintaining at least one other rank in the first power state. While the rank is in the second power state, the memory controller may determine that an activation trigger has occurred, such as a reduced-power timer satisfying a second threshold and/or the receipt of a command associated with the rank, prompting a transition of the rank from the second power state back to the first power state. In some aspects, the memory controller may receive an indication of threshold values via registers and/or may initialize the idle timer based on command completion or a wait period. Additionally, or alternatively, the memory controller may perform refresh operations associated with the rank before or after transitioning between power states. Moreover, the memory controller may switch the rank between per-bank and all-bank refresh pools in alignment with power state transitions and/or may manage entry and exit from self-refresh modes.

In this way, the memory controller may selectively shut down individual ranks within a channel based on rank activity, as opposed to shutting down entire channels, enabling more efficient power management tailored to the workload and memory usage patterns. Accordingly, the techniques described herein may enable conservation of energy resources by utilizing reduced power states more effectively and/or may reduce operational costs for systems requiring high-capacity memory. Additionally, or alternatively, the techniques described herein may enable maintenance of certain performance levels and/or may ensure data integrity through intelligent refresh operations. In some implementations, dynamic adjustment of power state thresholds in response to workload changes may result in optimized power consumption, delivering an adaptive approach to power management in LPDDR memory systems that conserves processing resources, memory resources, network resources, and/or the like.

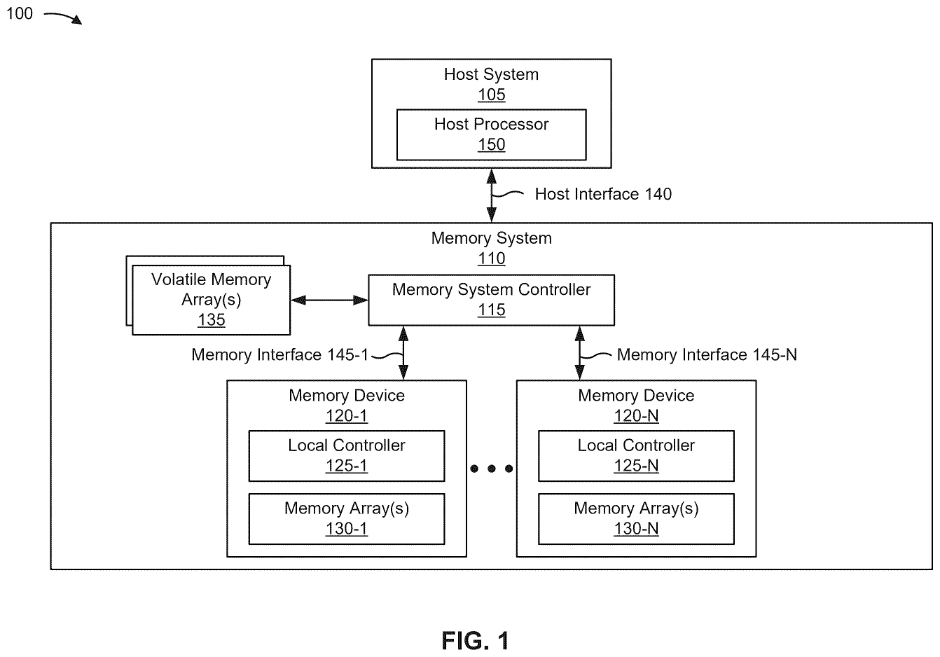

FIG. 1 is a diagram illustrating an example system 100 capable of per-rank power management operations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to determine that an idle timer for a rank of a memory channel, of multiple ranks of the memory channel, satisfies a first threshold; transition, based on determining that the idle timer for the rank satisfies the first threshold, the rank from a first power state to a second power state, wherein the second power state is lower than the first power state, and wherein at least one other rank of the memory channel is maintained in the first power state while the rank is transitioned from the first power state to the second power state; determine that an activation trigger has occurred, wherein the activation trigger includes at least one of: a determination that a reduced-power timer satisfies a second threshold, or reception of a command associated with the rank; and transition the rank from the second power state to the first power state in response to determining that the activation trigger has occurred.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

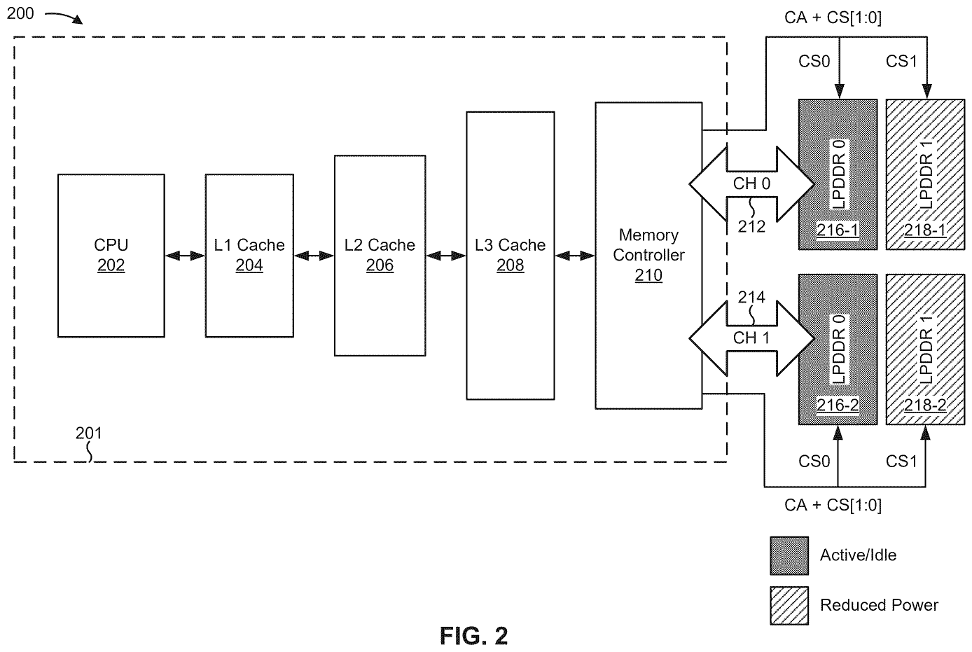

FIG. 2 is a diagram illustrating an example of a multi-rank memory system 200 capable of per-rank power management operations. The multi-rank memory system may be an LPDDR memory system, a DDR memory system (e.g., a DDR5 memory system), and/or another DRAM-based memory system based on a multi-rank configuration, among other examples. As shown in FIG. 2, the multi-rank memory system 200 may be associated with a multi-channel (e.g., dual-channel) memory controller, with multiple ranks (e.g., multiple memory components and/or dies) associated with each memory channel. More particularly, the multi-rank memory system 200 may include a system on chip (SoC) component 201 or similar component that consolidates multiple components of the multi-rank memory system 200 into a single chip. In such examples, the SoC component 201 may include a CPU 202, a level 1 (L1) cache 204, a level 2 (L2) cache 206, a level 3 (L3) cache 208, and/or a memory controller 210, among other examples. The CPU 202, which may correspond to the memory system controller 115, may be a main processing unit of the multi-rank memory system 200 that executes instructions and/or performs computations. In some implementations, the CPU 202 may serve as the brain of the multi-rank memory system 200, such as by managing the execution of programs and controlling other components and peripherals connected to the multi-rank memory system 200.

The L1 cache 204, L2 cache 206, and L3 cache 208 may be levels of cache memory that are used to temporarily store data and instructions that the CPU 202 frequently accesses. The memory controller 210 may coordinate and/or manage the flow of data between the CPU 202 and the memory modules of the multi-rank memory system 200. In some implementations, the memory controller 210 may perform operations associated with memory access control, timing and signal coordination, power management, error handling and correction, data buffering and caching, refresh management, QoS handling, interface management, thermal management, configuration and initialization, and/or similar operations.

In some implementations, the memory controller 210 may control operations associated with multiple memory channels and/or multiple ranks per memory channel. For example, in the example shown in FIG. 2, the memory controller 210 may be associated with two memory channels (CHs), shown as a first memory channel 212 (indexed as CH 0 in FIG. 2) and a second memory channel 214 (indexed as CH 1 in FIG. 2), but in other examples the memory controller 210 may be associated with more or fewer memory channels without departing from the scope of the disclosure. The memory channels 212, 214 may be a communication pathway or interface through which data is transferred between the memory controller 210 and the memory modules (such as LPDDR memory devices, described in more detail below). In some implementations, each memory channel 212, 214 may include a set of address, data, and/or control lines that facilitate the organized and efficient flow of information between the memory controller 210 and the memory.

In some implementations, each memory channel 212, 214 may be associated with multiple ranks. In the context of the multi-rank memory system 200, a rank may be a specific architecture within a memory channel where a set of memory chips (or devices) are combined to function as a single unit. In some implementations, a rank is created by combining the individual memory devices to collectively respond to a single memory access command from the memory controller. For example, in the implementation shown in FIG. 2, the multi-rank memory system 200 may be associated with a first rank 216 (indexed as LPDDR 0 in FIG. 2 and shown as first rank 216-1 in connection with the first memory channel 212 and first rank 216-2 in connection with the second memory channel 214) and a second rank 218 (indexed as LPDDR 1 in FIG. 2 and shown as second rank 218-1 in connection with the first memory channel 212 and second rank 218-2 in connection with the second memory channel 214). In some other implementations, each channel may be associated with more than two ranks without departing from the scope of the disclosure. Additionally, or alternatively, although the ranks 218, 220 are labeled as “LPDDR” for ease of description, in some other implementations, the ranks may be associated with a different type of multi-rank memory architecture, such as a DDR memory architecture (e.g., a DDR5 memory architecture), among other examples.

In such implementations, a command address (CA) may be shared across a given channel and may interleaved among the ranks (e.g., dies) associated with the channel. In some implementations, a single rank (e.g., a single die) may be enabled through a dedicated chip select (CS) to receive a command through the shared CA. For example, in some implementations, such as implementations in which the multi-rank memory system 200 is an LPDDR type 5 (LPDDR5) memory system, a memory controller address map may include bits rRRRRRRRRRRRRRRRRRbbbbcCCCCCC, in which r corresponds to a rank bit (e.g., a CS bit and/or a bit used to indicate which rank is to be accessed), R corresponds to row bits (e.g., bits used to indicate which row is to be accessed), b corresponds to bank bits (e.g., bits used to indicate which bank is to be accessed), c corresponds to a channel bit (e.g., bits used to indicate which channel is to be accessed), and C corresponds to column bits (e.g., bits used to indicate which column is to be accessed). In some other implementations, a different address map and/or differently arranged address map may be utilized without departing from the scope of the disclosure.

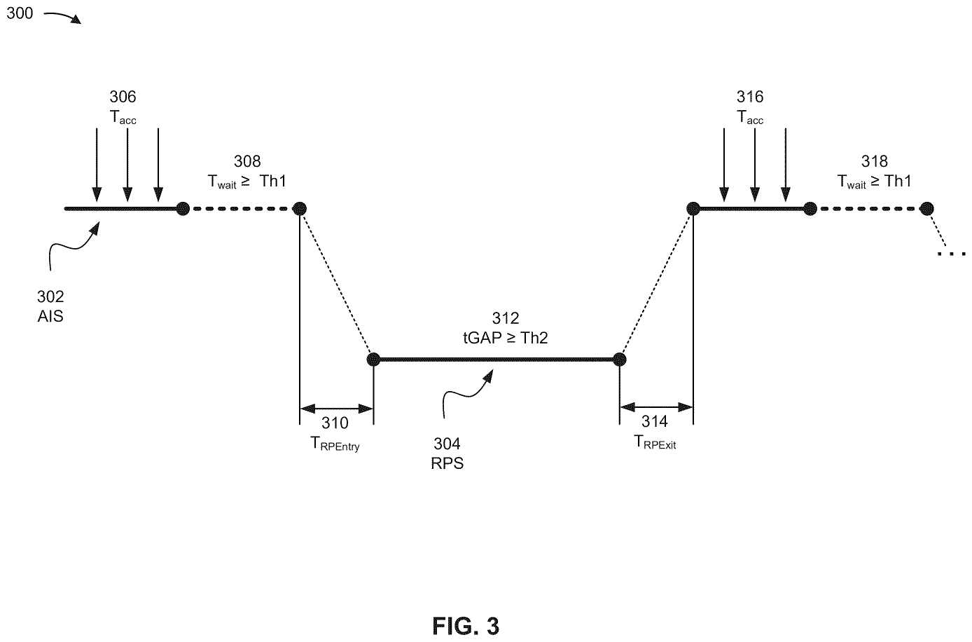

In some implementations, according to a selected address map, a workload (e.g., input commands) may be localized, by the memory controller 210, on a single rank across the two memory channels 212, 214, thereby enabling certain (e.g., unused) ranks to be shut down or otherwise be transitioned into a reduced power state to reduce power consumption at the multi-rank memory system 200 and/or increase power efficiency at the multi-rank memory system 200. For example, in some implementations, a workload may be localized on the first rank (e.g., LPDDR 0) such that the second rank (e.g., LPDDR 1) may be placed in a reduced power state. In such aspects, the first rank 216 (e.g., LPDDR 0) may be kept in an active or idle power state (shown in FIG. 2 using stippling) while the second rank 218 (e.g., LPDDR 1) may be placed in a reduced power state (shown in FIG. 2 using hatching), such as for a purpose of reducing power consumption at the multi-rank memory system 200. Although not shown, in some other implementations, multiple ranks may be placed in a reduced power state. For example, in implementations in which both the first rank 216 (e.g., LPDDR 0) and the second rank 218 (e.g., LPDDR 1) are idle, the first rank 216 and the second rank 218 may be placed in the reduce power state simultaneously. Aspects associated with transitioning one or more ranks to and from a reduced power state are described in more detail below in connection with FIG. 3.

As indicated above, FIG. 2 is provided as an example. Other examples may differ from what is described with regard to FIG. 2.

FIG. 3 is a diagram illustrating an example 300 associated with power state switching for a multi-rank memory system.

As shown in FIG. 3, a particular rank of a memory system (e.g., LPDDR 0 or LPDDR 1 of the multi-rank memory system 200, among other examples) may be transitioned between an active or idle state (AIS) 302 and a reduced power state (RPS) 304 (sometimes referred to herein as entering a power down state). The RPS 304 may be a power state that is lower than the AIS 302 such that, while in the RPS 304, the rank may consume only a fraction of the power that the rank consumes while in the AIS 302. For example, the RPS 304 may be associated with a state in which input and output buffers (except for CS and/or a reset buffer, sometimes referred to as RESET_n) associated with a given rank are deactivated to reduce power consumption for the rank. In some implementations, the AIS 302 may be associated with a state in which the input and output buffers associated with a given rank are activated and/or may correspond to an active state when the memory controller 210 has commands targeting the rank and to an idle state when there are no commands targeting the rank. In such implementations, the RPS 304 may be a power state associated with less power consumption than both the active state and the idle state. Additionally, or alternatively, if power-down (e.g., transitioning from the AIS 302 to the RPS 304) occurs when all banks for the rank are idle, the RPS 304 may be referred to as an idle power-down state. Moreover, if power-down occurs when there is a row active in any bank for the rank, the RPS 304 may be referred to as an active power-down state.

While in the AIS 302, the rank may be associated with a command interval 306 (sometimes referred to herein as an access time (T_{acc}) and shown using a solid line in connection with the AIS 302), which is a period of time during which one or more commands target the rank (shown in FIG. 3 using multiple downward extending arrows). The one or more commands may include access commands (e.g., read and/or write commands) and/or management commands, such as refresh (REF) commands and/or similar commands. Moreover, while in the AIS 302, the rank may be associated with a no-commands interval 308 (sometimes referred to herein as a wait time (T_{wait}) and shown using a broken line in connection with the AIS 302), which is a period of time during which no commands target the rank. In some implementations, once the T_{wait} is at least as long as a first threshold (Th1), the rank may be transitioned to the RPS 304, such as for a purpose of conserving power at the memory system when no commands are targeting the rank. For example, as described in more detail below, the rank may be associated with an idle timer, which may be initialized after all pending commands for a rank (e.g., the commands shown in connection with the command interval 306) have been completed. In such implementations, a memory controller may determine that the idle timer for the rank satisfies a first threshold (e.g., Th1) and/or may transition the rank from the AIS 302 to the RPS 304 based on determining that the idle timer for the rank satisfies the first threshold.

In some implementations, the rank may be associated with a first transition time 310, which may be a time period during which the rank is transitioned from the AIS 302 to the RPS 304 and/or which is sometimes referred to herein as a reduced power state entry time (T_{RPEntry}). The rank may then be maintained in the RPS 304 for a certain time, sometimes referred to herein as a reduced power time 312 and/or a gap time (tGAP). In such implementations, after tGAP is at least as long a second threshold (Th2), the rank may be transitioned back to the AIS 302, such as for a purpose of executing any new commands targeting the rank. For example, as described in more detail below, the rank may be associated with a reduced-power timer, which may be initialized after the rank enters the RPS 304. In such implementations, a memory controller may determine that the reduced-power timer for the rank satisfies a second threshold (e.g., Th2) and/or may transition the rank from the RPS 304 to the AIS 302 based on determining that the reduced-power timer for the rank satisfies the second threshold.

In some implementations, the rank may be associated with a second transition time 314, which may be a time period during which the rank is transitioned from the RPS 304 to the AIS 302 and/or which is sometimes referred to herein as a reduced power state exit time (T_{RPExit}). Additionally, or alternatively, in some implementations, the first transition time 310 (e.g., T_{RPEntry}) and/or the second transition time 314 (e.g., T_{RPExit}) may vary according to a type of power state associated with the RPS 304. For example, the RPS 304 may be associated with one of a power down (PDN) state, a deep sleep state, or a similar reduced power state, and the first transition time 310 and/or the second transition time 314 may vary for each type of reduced power state. Additionally, or alternatively, a minimum value of the reduced power time 312 (e.g., tGAP) and/or the second threshold (e.g., Th2) may vary depending on the type of reduced power state employed.

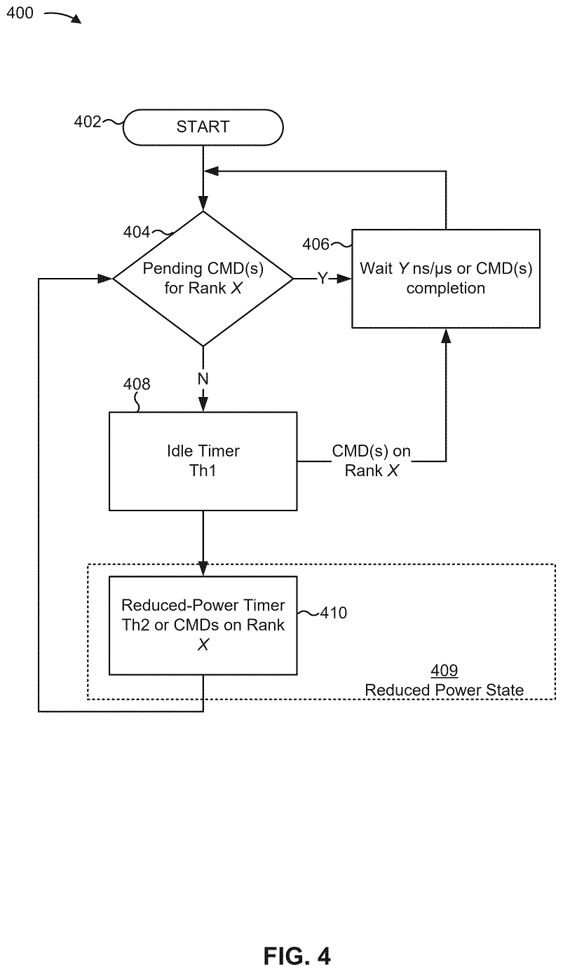

Following the second transition time 314, the above-described operations may generally repeat, such that, following a command interval 316 (e.g., a period of time during which the one or more commands target the rank, which may be substantially similar to the command interval 306), the rank may be associated with a no-commands interval 318 (e.g., a period of time during which no commands target the rank and/or which may be substantially similar to no-commands interval 308), and thus the memory controller may implement an idle timer to determine if the rank should once again be transitioned to the RPS 304. Aspects of entering and exiting a reduced power state is described in more detail below in connection with FIG. 4.

As indicated above, FIG. 3 is provided as an example. Other examples may differ from what is described with regard to FIG. 3.

FIG. 4 is a diagram illustrating an example 400 associated with per-rank power management operations for a multi-rank memory system. In some implementations, the operations shown in FIG. 4 may be performed by a memory controller, such as memory controller 210 of the multi-rank memory system 200 and/or the local controller 125 of the memory system 110, and/or by a state machine located within and/or otherwise associated with a memory controller.

The example 400 may start (indicated by reference number 402), such as by powering up a multi-rank memory system (e.g., the multi-rank memory system 200) and/or otherwise initiating a power management operation for a given rank (shown in FIG. 4 as Rank X) of the multi-rank memory system. Although the examples shown and described in connection with FIGS. 4-10 are directed to a single rank (e.g., Rank X) for ease of description, in some other implementations multiple ranks may be placed into a reduced power state simultaneously. Put another way, in some implementations the power states for multiple ranks of a multi-rank memory system may be independently controlled and/or switched such that, at some times, no ranks will be in the reduced power state, at other times, a single rank may be transitioned to the reduced power state, and, at still other times, multiple ranks may be transitioned to the reduced power state. As indicated by reference number 404, the example 400 may include determining whether there are any pending commands (CMDs) for Rank X. If yes (shown using an arrow labeled “Y” in FIG. 4), the example 400 may include waiting before proceeding (e.g., such that the pending commands may be completed before checking again if there are additional pending commands related to the same rank), as indicated by reference number 406. For example, in some implementations the memory controller may wait a certain period of time, such as Y nanoseconds (ns) or microseconds (μs), among other examples. In some other implementations, the memory controller may wait for all commands to be complete. The memory controller may continue in a like manner until all pending commands have been completed for Rank X.

Once there are no longer pending commands for Rank X, shown using an arrow labeled “N” in connection with the operations indicated by reference number 404, the example 400 may include initiating an idle timer (as indicated by reference number 408), such as the idle timer described above in connection with the no-commands interval 308. In that regard, and in a similar manner as described above, the example 400 may include determining whether the idle timer satisfies a first threshold (e.g., Th1). For example, if any additional commands (CMDs) are received for Rank X prior to the idle timer satisfying the first threshold (shown in FIG. 4 using the arrow labeled “CMD(s) on Rank X”), the example 400 may include performing the operations described above in connection with reference number 406. However, if the idle timer satisfies the first threshold with no commands being received for Rank X, the example 400 may include transitioning the Rank X to a reduced power state 409 (e.g., RPS 304, shown in FIG. 4 using a broken-line box), in a similar manner as described above in connection with FIG. 3.

Moreover, transitioning the Rank X to the reduced power state 409 may be performed independent of other ranks associated with the memory channel. For example, in a memory system associated with at least two ranks per memory channel, such as the multi-rank memory system 200, the memory controller 210 may transition a rank (e.g., one of LPDDR 0 or LPDDR 1) to the reduced power state 409 while maintaining another rank (e.g., the other one of the LPDDR 0 or LPDDR 1) in an active or idle state (e.g., AIS 302). Put another way, in some implementations the example 400 may include determining that an idle timer for a rank of a memory channel (e.g., one of LPDDR0 or LPDDR 1) satisfies a first threshold (e.g., Th1), and thus may include transitioning the rank from a first power state (e.g., AIS 302) to a second power state (e.g., RPS 304) lower than the first power state, while maintaining at least one other rank of the memory channel (e.g., the other one of LPDDR 0 or LPDDR 1) in the first power state.

As indicated by reference number 410, in some implementations the Rank X may be maintained in the reduced power state 409 until a reduced-power timer satisfies a second threshold (e.g., Th2). More particularly, in a similar manner as described above in connection with the reduced power time 312 and/or tGAP, Rank X may be associated with a reduced-power timer, which may be initialized after the rank enters the reduced power state 409. In such implementations, the example 400 may include determining that the reduced-power timer for the rank satisfies a second threshold (e.g., Th2) and/or transitioning the rank from the reduced power state 409 to the active or idle state (e.g., AIS 302) based on determining that the reduced-power timer for Rank X satisfies the second threshold. Put another way, the example 400 may include determining that a reduced-power timer satisfies a second threshold (e.g., Th2) and thus transitioning Rank X from the second power state (e.g., RPS 304) to the first power state (e.g., AIS 302) in response to determining that the reduced-power timer satisfies the second threshold.

In some other implementations, the example 400 may include transitioning Rank X from the second power state to the first power state based on some other type of trigger (sometimes referred to herein as an activation trigger), such as the memory controller receiving a command targeting Rank X. Put another way, in some implementations, the example 400 may include receiving a command associated with Rank X, and thus may include transitioning Rank X from the second power state (e.g., RPS 304) to the first power state (e.g., AIS 302) in response to receiving the command. As shown using the arrow extending from the box indicated by reference number 410, once Rank X is transitioned to the first power state, the example 400 may include generally repeating the operations described above, beginning with the operations indicated by reference number 404.

In some implementations, a memory system implementing example 400 may receive an indication of one or more parameters associated with example 400 from a host system (e.g., host system 105), such as via one or more registers associated with the memory system. For example, the memory controller may receive, from a host system via one or more registers associated with the memory system, an indication of at least one of the first threshold (e.g., Th1) or the second threshold (e.g., Th2). Additionally, or alternatively, and in a similar manner as described above in connection with FIG. 3, a type of reduced power mode to be implemented (e.g., a power-down mode, a self-refresh mode, a deep-sleep mode, and/or the like) may vary according to a particular low-power capability of a memory system implementing the example 400, and/or one or more parameters may vary according to a type of reduced power mode implemented. Put another way, registers values (such as a Th1 configuration and/or a Th2 configuration) may change according to the type of reduced power state. In that regard, a power-conserving benefit associated with transitioning Rank X to the reduced power state in the manner described above may depend on the particular parameters implemented (e.g., Th1, Th2) and/or a type of reduced power state implemented. For example, a power-conserving benefit may generally increase with Th2, among other examples.

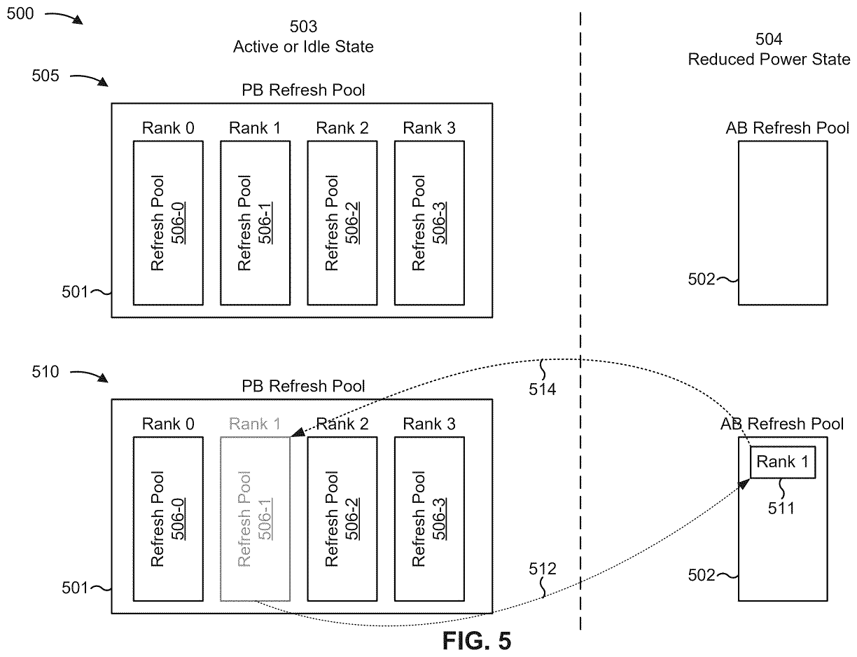

In some implementations, a memory controller may perform various refresh operations based on transitioning a rank between power modes and/or may switch between various refresh operations for the rank in response to transitioning the rank between power states. Aspects of performing refresh operations for a rank and/or switching refresh modes associated with the rank upon transitioning the rank between multiple power states are described in more detail below in connection with FIGS. 5-9.

As indicated above, FIG. 4 is provided as an example. Other examples may differ from what is described with regard to FIG. 4.

FIG. 5 is a diagram illustrating an example 500 associated with refresh mode switching for a multi-rank memory system.

In some implementations, such as implementations in which memory components of a memory system (e.g., memory components associated with the first rank 216 and the second rank 218) are volatile memory components (e.g., SDRAM components, among other examples), the memory controller may periodically perform a refresh operation in order to maintain an integrity of data stored at the memory components. In such implementations, the memory controller may refresh the data using either a per-bank (PB) refresh operation or other small granularity refresh operation (e.g., a same-bank refresh operation) or an all-bank (AB) refresh operation. “Bank” refers to a distinct segment or division within a memory chip or module that can be independently accessed and operated on, with each bank in a memory system containing a portion of the memory array. In this regard, in some implementations, such as implementations in which a PB refresh operation is utilized, while one bank is being read, another can be precharged or refreshed. For ease of description, “PB refresh operation” is used herein to refer to any refresh operation performed at a smaller granularity than an AB refresh operation, and thus covers a PB refresh operation, a same-bank refresh operation, and/or similar refresh operations having a granularity smaller than an AB refresh operation.

More particularly, in a PB refresh operation, each bank may be refreshed independently, allowing for more fine-grained control over refresh operations and/or which may reduce latency since not all banks need to be refreshed simultaneously. For example, in some implementations, a given rank (e.g., Rank X) may be associated with multiple banks, such as sixteen banks indexed 0 to 15. The rank may be associated with a refresh pool in which a pair of banks is refreshed every configured time interval (e.g., a pair of banks may be refreshed every 480 ns, among other examples). In such implementations, at a start of a refresh cycle, a refresh pool may include all sixteen banks (e.g., the refresh pool may be reset at the commencement of each refresh cycle to include banks 0-15). The memory controller may then refresh, during a first portion of the refresh cycle, a pair of banks (while leaving the remaining banks operable), such as banks indexed 7 and 15, among other examples. In such examples, banks 7 and 15 may be removed from the refresh pool, leaving only unrefreshed banks in the pool (e.g., banks 0-6 and 8-14). Similarly, the memory controller may refresh, during a second portion of the refresh cycle, another pair of banks (such as banks indexed 4 and 12), and thus may remove banks 4 and 12 from the refresh pool, leaving only unrefreshed banks in the pool (e.g., banks 0-3, 5-6, 8-11, and 13-14). The memory controller may proceed in a similar manner until the refresh cycle is complete (e.g., until all sixteen banks have been refreshed), at which point the refresh pool may be reset (e.g., such that all banks are again associated with the refresh pool) and the memory controller may once again perform a refresh cycle in a like manner. Put another way, the refresh pool may be emptied before a new refresh cycle may begin. Additionally, or alternatively, the order in which the various banks are refreshed during a given refresh cycle may change, such as for a purpose of minimizing maintenance collisions, among other examples.

In some other implementations, the memory controller may use an AB refresh operation. An AB refresh operation may refer to an approach in which all banks of a memory (e.g., a rank of memory) are refreshed at the same time. In some implementations, an AB refresh operation may be simpler to implement than a PB refresh operation, but the AB refresh operation may momentarily halt memory operations since no part of the memory (e.g., rank) may be accessed during the refresh period. A refresh type (e.g., one of PB refresh or AB refresh) to be used by the memory controller may be defined at power up of the memory system and/or may typically remain unchanged during the usage of the memory system.

In some implementations described herein, a memory system (e.g., Multi-rank memory system 200) may utilize a pair of refresh pools to track global refresh commands, such as for a purpose of enabling a capability of the memory system to switch between PB refresh and AB refresh in a single rank (e.g., Rank X). For example, a rank may be associated with a PB refresh operation when in a first power state (e.g., the AIS 302), such as for a purpose of enabling each bank to be refreshed independently and thus enabling more fine-grained control over refresh operations and/or reducing latency since not all banks need to be refreshed simultaneously. On the other hand, a rank may be associated with an AB refresh operation when in a second (e.g., lower) power state (e.g., the RPS 304), such as for a purpose of implementing a simpler (and thus less resource intensive) refresh operation when the rank is not actively being accessed.

More particularly, as shown by example 500, a memory system may utilize a PB refresh pool 501 and an AB refresh pool 502. The PB refresh pool 501 and/or the AB refresh pool 502 may contain a refresh pool for one or more ranks. For example, in some implementations, when a rank is in an active or idle state 503 (e.g., AIS 302), a corresponding refresh pool may be part of the PB refresh pool 501, and thus the rank may be refreshed using a PB refresh operation. On the other hand, when a rank is in a reduced power state 504 (e.g., RPS 304), a corresponding refresh pool may be part of the AB refresh pool 502, and thus the rank may be refreshed using an AB refresh operation.

More particularly, in the example 500, a memory system may be associated with four ranks, indexed in FIG. 5 as Rank 0 through Rank 3. As indicated by reference number 505, at a first time, all four ranks may be in the active or idle state 503, and thus all four ranks may be associated with a PB refresh operation. In this regard, a refresh pool 506 associated with each rank (shown in FIG. 5 as a first refresh pool 506-0 through a fourth refresh pool 506-3, corresponding to Rank 0 through Rank 3, respectively) may be maintained by the memory controller in the PB refresh pool 501 (and thus the AB refresh pool 502 may be empty). Accordingly, each rank may be refreshed using a PB refresh operation, in a similar manner as described above. For example, assuming each rank is associated with sixteen banks and/or that a pair of banks are refreshed at a time (as described above), the memory controller may refresh each rank by refreshing a first pair of banks during a first portion of the refresh cycle, by refreshing a second pair of banks during a second portion of the refresh cycle, and so forth through refreshing an eighth pair of banks during an eighth portion of the refresh cycle (at which point the corresponding refresh pool 506 may be reset and a new refresh cycle may commence).

However, as indicated by reference number 510, at a second time there may be four ranks in the active or idle state 503 (e.g., Rank 0, Rank 2, and Rank 3, which thus may be associated with the PB refresh operation), but Rank 1 may have been transitioned to the reduced power state 504. In this regard, the first refresh pool 506-0, a third refresh pool 506-2, and the fourth refresh pool 506-3 (corresponding to Rank 0, Rank 2, and Rank 3, respectively) may be maintained by the memory controller in the PB refresh pool 501, while Rank 1 may be moved to the AB refresh pool 502, as indicated by reference number 511. Accordingly, Ranks 0, 2, and 3 may be refreshed using a PB refresh operation, in a similar manner as described above. However, Rank 1, while in the reduced power state 504, may be refreshed using an AB refresh operation (e.g., a refresh operation in which all banks in Rank 1 are refreshed at the same time).

In some implementations, switching a rank (e.g., Rank 1 in example 500) to an AB refresh operation while in the reduced power state 504 may enable the memory system to maintain the rank in the reduced power state 504 for a longer duration than if the rank was kept in the PB refresh operation, thereby conserving power. More particularly, to execute a refresh command on a rank, a memory system may need to exit the rank from the reduced power state 504 into the active or idle state 503. Moreover, a refresh frequency associated with an AB refresh operation may be low compared to a refresh frequency associated with a PB refresh operation. For example, for an LPDDR5 memory system or similar system, a refresh frequency associated with an AB refresh operation may be approximately 3900 ns while a refresh frequency associated with a PB refresh operation may be approximately 490 ns. In this way, switching a rank to the AB refresh pool 502 when the rank is placed in the reduced power state 504 may enable the rank to remain in the reduced power state 504 for a longer duration than if the rank was maintained in the PB refresh pool 501, thereby conserving power resources.

In that regard, a rank may be switched between a PB refresh operation (sometimes referred to herein as “REFpb”) and an AB refresh operation (sometimes referred to herein as “REFab”) as the rank is transitioned between the active or idle state 503 and the reduced power state 504. For example, as indicated using the arrow labeled with reference number 512, when Rank 1 is transitioned from the active or idle state 503 to the reduced power state 504, Rank 1 may be switched from the PB refresh pool 501 to the AB refresh pool 502. Similarly, as indicated using the arrow labeled with reference number 514, when Rank 1 is transitioned from the reduced power state 504 to the active or idle state 503, Rank 1 may be switched back from the AB refresh pool 502 to the PB refresh pool 501.

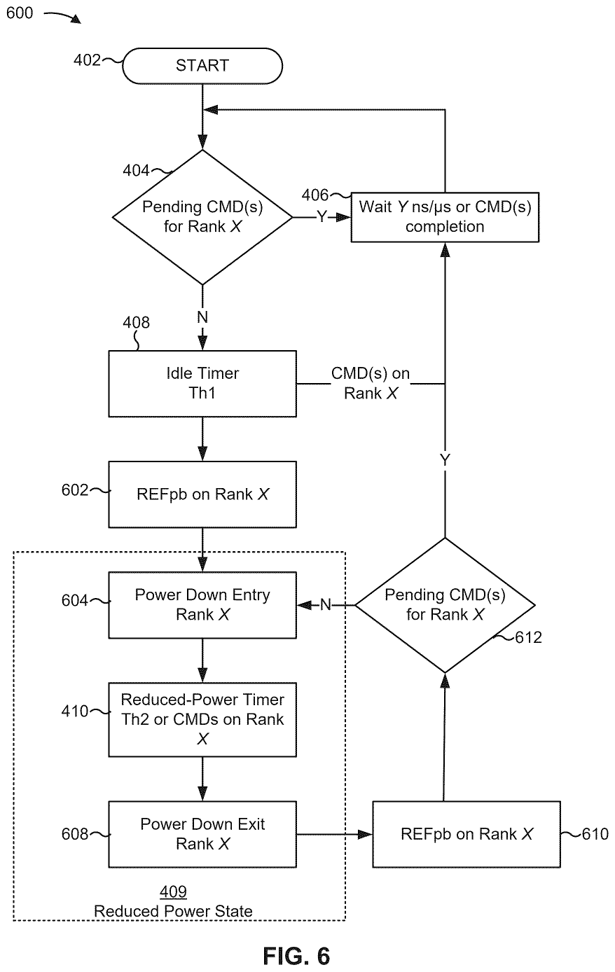

In some implementations, when a rank is moved from REFpb to REFab, such as when Rank 1 is moved from the PB refresh pool 501 to the AB refresh pool 502 as indicated by the arrow labeled with reference number 512, a refresh command may be used by the memory controller to reset the device counters (e.g., the idle timer and/or the reduced-power timer described above in connection with FIG. 3, among other examples). Additionally, or alternatively, in some implementations, REFab and/or REFpb commands may be served according to the commands traffic and/or timings in an interleaved way to update the PB refresh pool 501 and/or AB refresh pool 502. Moreover, in implementations in which REFab is used as a default refresh operation (e.g., in implementations in which the memory controller is configured at power on to refresh the memory components using a REFab command), ranks may remain in the AB refresh pool 502 in both the active or idle state 503 and the reduced power state 504 (e.g., there may be no refresh pool switch in implementations in which REFab is set as a default refresh operation). Aspects associated with using various refresh operations and/or switching different types of refresh operations are described in more detail below in connection with FIGS. 6-9.

As indicated above, FIG. 5 is provided as an example. Other examples may differ from what is described with regard to FIG. 5.

FIG. 6 is a diagram illustrating another example 600 associated with per-rank power management operations for a multi-rank memory system. In some implementations, the operations shown in FIG. 6 may be performed by a memory controller, such as memory controller 210 of the multi-rank memory system 200 and/or the local controller 125 of the memory system 110, and/or by a state machine located within and/or otherwise associated with a memory controller. In some implementations, the example 600 includes similar steps and/or operations as some of the steps and/or operations described above in connection with FIG. 4, and thus which are shown in FIG. 6 using like-named and like-numbered operations and which are not described again in detail for ease of description.

In the example 600 shown in FIG. 6, a particular rank (e.g., Rank X) that is transitioned from an active or idle state to a reduced power state (e.g., reduced power state 409) may be refreshed prior to entering the reduced power state and/or upon exiting the reduced power state, such as for a purpose of ensuring data integrity while the rank is in the reduced power state. Put another way, in some implementations the low-power management techniques described herein may include refreshing a rank upon entering and/or exiting a reduced power mode to preserve data on the rank that may otherwise be lost during the reduced power state (because data may not be otherwise preserved and/or refreshed while in the reduced power state), and/or to enable the rank to be maintained in the reduced power state for a longer time period than would otherwise be obtainable if the rank needed to be transitioned to the active or idle state to perform a refresh operation.

More particularly, following the operations described above in connection with reference number 408 (e.g., in response to determining that an idle timer for Rank X satisfies a first threshold (e.g., Th1)), the example 600 may include performing a refresh operation on Rank X, as indicated by reference number 602. For example, in some implementations (e.g., the implementation shown in FIG. 6), the example 600 may include performing a PB refresh operation (e.g., REFpb) on Rank X, while, in some other implementations, the example 600 may include performing an AB refresh operation (e.g., REFab) on Rank X. As indicated by reference number 604, the example 600 may then include performing a power-down entry for Rank X (e.g., deactivating certain input and/or output buffers associated with Rank X).

In some implementations, the example 600 may include initiating a reduced-power timer and/or comparing the reduced-power timer with a threshold (e.g., Th2) in a similar manner as described above in connection with reference number 410. However, because in this implementation Rank X may be refreshed prior to transitioning to the reduced power state (as described above in connection with reference number 602), the rank may be maintained in the reduced power state 409 for a longer duration than would otherwise be possible absent performance of the refresh operation. Put another way, in some implementations, performing the refresh operation on the rank prior to transitioning the rank to the reduced power state 409 may enable a larger second threshold (e.g., Th2) to be implemented by the memory controller. For example, in some implementations the second threshold may be aligned to a PB refresh interval associated with the rank, such as 490 ns, among other examples.

Once the reduced-power timer for the rank satisfies a second threshold (e.g., Th2) and/or once a command is received for Rank X (as described above in connection with reference number 410), the example 600 may include performing a power down exit procedure for Rank X (e.g., activating certain input and/or output buffers associated with Rank X), as indicated by reference number 608. As indicated by reference number 610, upon exiting the reduced power state 409, the example 600 may include performing a refresh operation on Rank X, such as a PB refresh operation (e.g., REFpb, as shown in FIG. 6) and/or an AB refresh operation (e.g., REFab, not shown in FIG. 6). As indicated by reference number 612, upon completion of the refresh operation, the example 600 may include determining whether there are any pending commands targeting Rank X. If there are no pending commands targeting Rank X (shown in FIG. 6 using the arrow labeled “N” in connection with the operations indicated by reference number 612), the example 600 may include transitioning the rank back to the reduced power state 409. However, if there are pending commands targeting Rank X (shown in FIG. 6 using the arrow labeled “Y” in connection with the operations indicated by reference number 612), the example 600 may proceed to the operations described above in connection with reference number 406 and thereafter in a similar manner as described above.

In some implementations, a memory system implementing example 600 may receive, from a host system, an indication of one or more parameters enabling the operations described above, such as via one or more registers associated with the memory system. For example, in some implementations, the memory system may receive an indication of the first threshold (e.g., Th1) and/or the second threshold (e.g., Th2, which may have a maximum value corresponding to a refresh interval (REFI) time, such as a PB refresh interval time (tREFIpb), which may be 490 ns, among other examples). Additionally, or alternatively, the memory system may receive an indication of an activation trigger for exiting the reduced power state 409 (as described above in connection with reference number 410), such as whether the rank should be transitioned to the active or idle state upon the reduced-power timer satisfying the threshold and/or upon the memory system receiving a command targeting the rank. Additionally, or alternatively, the memory system may receive an indication of conditions to be followed after command completion (as described above in connection with reference number 406), such as whether the rank should be transitioned to the reduced power state immediately upon command competition or whether the memory system should wait for a configured wait period (e.g., Y ns/μs) after command completion to transition the rank to the reduced power state. In such examples, the memory system (e.g., the memory controller) may initialize the idle timer based on completion of a last-received command when the configuration information indicates that the rank should be transitioned to the reduced power state immediately upon command competition, and the memory system may initialize the idle timer based on a wait period (e.g., Y ns/μs) elapsing when the configuration information indicates that the memory system should wait for the configured wait period after command completion to transition the rank to the reduced power state.

As indicated above, FIG. 6 is provided as an example. Other examples may differ from what is described with regard to FIG. 6.

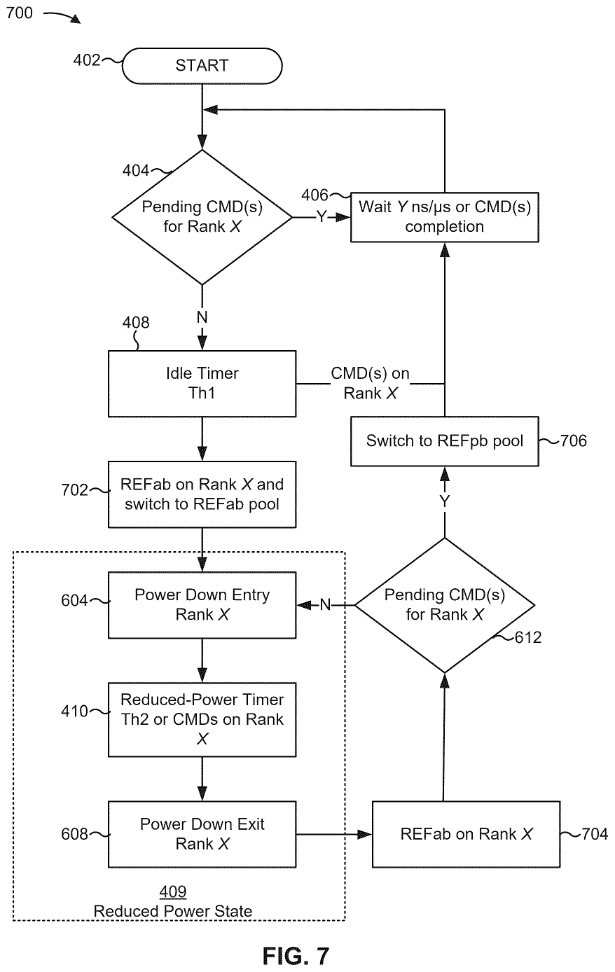

FIG. 7 is a diagram illustrating another example 700 associated with per-rank power management operations for a multi-rank memory system. In some implementations, the operations shown in FIG. 7 may be performed by a memory controller, such as memory controller 210 of the multi-rank memory system 200 and/or the local controller 125 of the memory system 110, and/or by a state machine located within and/or otherwise associated with a memory controller. In some implementations, the example 700 includes similar steps and/or operations as some of the steps and/or operations described above in connection with FIG. 4 and FIG. 6, and thus which are shown in FIG. 7 using like-named and numbered operations and which are not described again in detail for ease of description.

In the example 700 shown in FIG. 7, a particular rank (e.g., Rank X) that is transitioned from an active or idle state to a reduced power state may be switched from one type of refresh operation (e.g., one of a PB or AB refresh operation) to another type of refresh operation (e.g., the other one of the PB or AB refresh operation). For example, in some implementations the low-power management techniques described herein may include switching, prior to transitioning a rank (e.g., Rank X) from the first power state (e.g., an active or idle state) to the second power state (e.g., the reduced power state 409), the rank from a PB refresh pool (e.g., PB refresh pool 501) to the AB refresh pool (e.g., AB refresh pool 502), and/or switching, after transitioning the rank from the second power state to the first power state, the rank from the AB refresh pool to the PB refresh pool. In such implementations, the example 700 may enable the benefits of the PB refresh operation (e.g., staggered refreshing of banks, thereby reducing latency associated with executing commands) while in the active or idle state, while enabling the use of simpler, less resource intensive refresh operation (e.g., AB refresh operations) while in the reduced power state.

More particularly, following the operations described above in connection with reference number 408 (e.g., in response to determining that an idle timer for Rank X satisfies a first threshold (e.g., Th1)), the example 700 may include performing a refresh operation on Rank X, as indicated by reference number 702. Moreover, in this implementation, the example 700 may include switching a type of refresh operation associated with the rank. For example, the memory system may be configured (e.g., via a register parameter) to perform a PB refresh operation while the rank is in the active or idle state. In such implementations, the example 700 may include switching the rank to the AB refresh operation (e.g., switching the rank to the AB refresh pool 502) and/or performing a refresh operation on the rank (e.g., a REFab operation) prior to entering the reduced power state 409. The operations performed while in the reduced power state 409 may be substantially similar to the operations described above in connection with reference numbers 604, 410, and 608.

In that regard, once the reduced-power timer for the rank satisfies a second threshold (e.g., Th2) and/or once a command is received for Rank X (as described above in connection with reference number 410), the example 700 may include performing a power down exit procedure for Rank X (e.g., activating certain input and/or output buffers associated with Rank X), as described above in connection with reference number 608. As indicated by reference number 704, upon exiting the reduced power state 409, the example 700 may include performing a refresh operation on Rank X, such as an AB refresh operation (e.g., REFab, as shown in FIG. 7) in this implementation because the rank was moved to the AB refresh pool in the operations described above in connection with reference number 702. Then, in a similar manner as described above in connection with reference number 612, upon completion of the refresh operation, the example 700 may include determining whether there are any pending commands targeting Rank X. If there are no pending commands targeting Rank X (shown in FIG. 7 using the arrow labeled “N” in connection with the operations indicated by reference number 612), the example 700 may include transitioning the rank back to the reduced power state 409.

However, in this implementation, if there are pending commands targeting Rank X (shown in FIG. 7 using the arrow labeled “Y” in connection with the operations indicated by reference number 612), the example 700 may include switching the rank to a PB refresh operation and/or a PB refresh pool (e.g., REFpb pool and/or PB refresh pool 501), as indicated by reference number 706. The example 700 may then proceed to the operations described above in connection with reference number 406 and/or thereafter in a similar manner as described above.

In a similar manner as described above in connection with example 600, a memory system implementing example 700 may receive, from a host system, an indication of one or more parameters enabling the operations described above, such as via one or more registers associated with the memory system. For example, in some implementations, the memory system may receive an indication of the first threshold (e.g., Th1) and/or the second threshold (e.g., Th2, which, in this implementation, may have a maximum value corresponding to an AB refresh interval time (tREFIab), which may be 3.9 μs, among other examples). Additionally, or alternatively, the memory system may receive an indication of an activation trigger for exiting the reduced power state (as described above in connection with reference number 410), such as whether the rank should be transitioned to the active or idle state upon the reduced-power timer satisfying the threshold and/or upon the memory system receiving a command targeting the rank. Additionally, or alternatively, the memory system may receive an indication of conditions to be followed for after command completion (as described above in connection with reference number 406), such as whether the rank should be transitioned to the reduced power state immediately upon command competition or whether the memory system should wait for a configured wait period (e.g., Y ns/μs) after command completion to transition the rank to the reduced power state.

As indicated above, FIG. 7 is provided as an example. Other examples may differ from what is described with regard to FIG. 7.

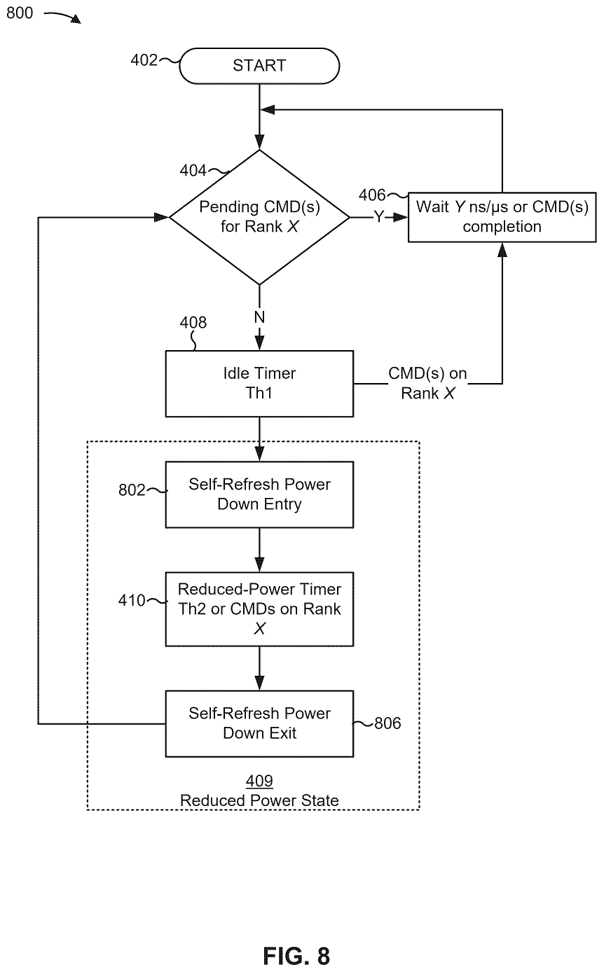

FIG. 8 is a diagram illustrating another example associated with per-rank power management operations for a multi-rank memory system. In some implementations, the operations shown in FIG. 8 may be performed by a memory controller, such as memory controller 210 of the multi-rank memory system 200 and/or the local controller 125 of the memory system 110, and/or by a state machine located within and/or otherwise associated with a memory controller. In some implementations, the example 800 includes similar steps and/or operations as some of the steps and/or operations described above in connection with FIG. 4, and thus which are shown in FIG. 8 using like-named and like-numbered operations and which are not described again in detail for ease of description.

In the example 800 shown in FIG. 8, a particular rank (e.g., Rank X) that is transitioned from an active or idle state to a reduced power state may be switched to a self-refresh mode while in the reduced power state. In a self-refresh mode, data at a memory component (e.g., SRAM component) may be preserved due to an internal refresh operation, and thus no additional activity may be required by the memory system to preserve data (e.g., the rank need not be exited from the reduced power state to perform a refresh operation, among other examples). For example, in some implementations, the memory system may enter, based on transitioning a given rank (e.g., Rank X) from the active or idle power state to the reduced power state, the rank into a self-refresh mode, and/or the memory system may exit, based on transitioning the rank from the reduced power state to the active or idle power state, the rank from the self-refresh mode. In such implementations, power consumption at the memory system may further be reduced because self-refresh power consumption may be relatively small as compared to a standard refresh power consumption. However, such power savings benefits may come at a cost of increased latency because transitioning the rank to and/or from a self-refresh mode may be associated with a relatively long duration (e.g., 500 ns, among other examples).

For example, as indicated by reference number 802, upon the idle timer satisfying the first threshold (e.g., Th1), the example 800 may include performing a self-refresh power down entry for Rank X. In such implementations, the self-refresh power down entry may include deactivating input and/or output buffers associated with Rank X and/or switching Rank X to a self-refresh mode, as described above. In some implementations, the example 800 may include initiating a reduced-power timer and/or comparing the reduced-power timer with a threshold (e.g., Th2), in a similar manner as described above in connection with reference number 410. However, because in this implementation Rank X may be in a self-refresh mode while in the reduced power state 409 (as described above in connection with reference number 802), the rank may be maintained in the reduced power state 409 for a longer duration than would otherwise be possible absent performance of the self-refresh operation. Put another way, in some implementations, switching the rank to the self-refresh operation may enable a larger second threshold (e.g., Th2) to be implemented by the memory controller because the rank may not need to be periodically exited from the reduced power state 409 to perform a refresh operation.

Once the reduced-power timer for the rank satisfies a second threshold (e.g., Th2) and/or once a command is received for Rank X (as described above in connection with reference number 410), the example 600 may include performing a self-refresh power down exit procedure for Rank X (e.g., activating certain input and/or output buffers associated with Rank X and/or exiting the self-refresh mode), as indicated by reference number 806. Upon exiting the reduced power state, the example 800 may proceed to the operations described above in connection with reference number 404 and/or thereafter in a similar manner as described above.

In some implementations, a memory system implementing example 800 may receive, from a host system, an indication of one or more parameters enabling the operations described above, such as via one or more registers associated with the memory system. For example, in some implementations, the memory system may receive an indication of the first threshold (e.g., Th1) and/or the second threshold (e.g., Th2, which may have no maximum value in this implementation because the rank may be switched to the self-refresh mode in the reduced power state, as described above). Additionally, or alternatively, the memory system may receive an indication of an activation trigger for exiting the reduced power state (as described above in connection with reference number 410), such as whether the rank should be transitioned to the active or idle state upon the reduced-power timer satisfying the threshold and/or upon the memory system receiving a command targeting the rank. Additionally, or alternatively, the memory system may receive an indication of conditions to be followed after command completion (as described above in connection with reference number 406), such as whether the rank should be transitioned to the reduced power state immediately upon command competition or whether the memory system should wait for a configured wait period (e.g., Y ns/μs) after command completion to transition the rank to the reduced power state, as described above.

As indicated above, FIG. 8 is provided as an example. Other examples may differ from what is described with regard to FIG. 8.

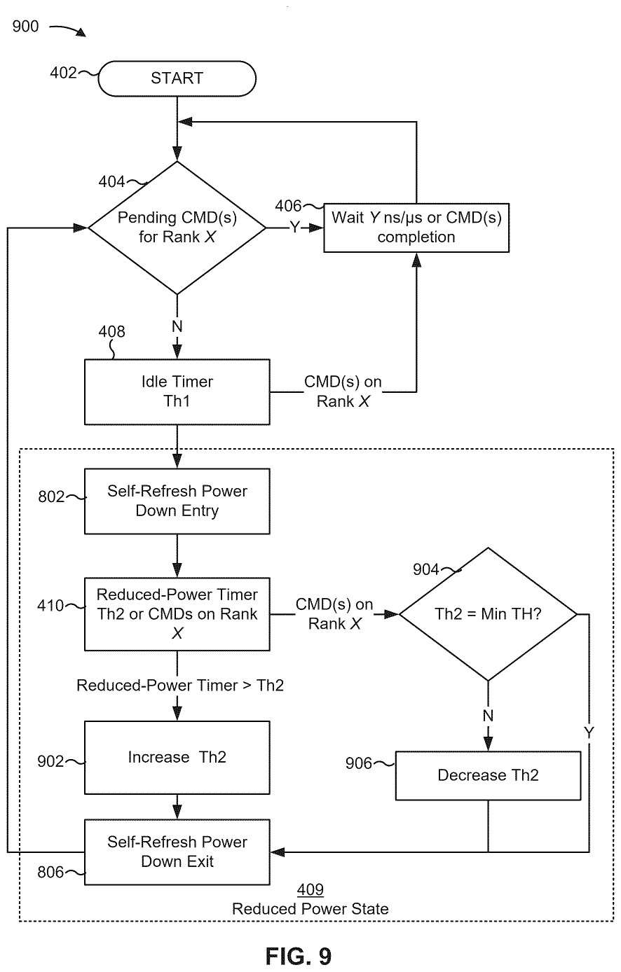

FIG. 9 is a diagram illustrating another example associated with per-rank power management operations for a multi-rank memory system. In some implementations, the operations shown in FIG. 9 may be performed by a memory controller, such as memory controller 210 of the multi-rank memory system 200 and/or the local controller 125 of the memory system 110, and/or by a state machine located within and/or otherwise associated with a memory controller. In some implementations, the example 900 includes similar steps and/or operations as some of the steps and/or operations described above in connection with FIG. 4 and FIG. 8, and thus which are shown in FIG. 9 using like-named and numbered operations and which are not described again in detail for ease of description.

In the example 900, a second threshold (e.g., Th2) associated with a particular rank (e.g., Rank X) may be dynamically adjusted, such as for a purpose of maintaining the rank in a reduced power state for longer durations when there is no activity at the rank (e.g., no commands targeting the rank) and/or for maintaining the rank in the reduced power state for shorter durations when there is increased activity at the rank. Put another way, a memory system may employ a dynamic second threshold for a purpose of maximizing a reduced power time (e.g., reduced power time 312 and/or tGAP). That is, because a command rate (e.g., a rate at which commands target a given rank) may be variable during usage of a memory device and/or may depend on workload, a fixed second threshold may limit the performance of certain power management operations when no commands are targeting a given rank. Accordingly, in some implementations, the example 900 may include increasing the second threshold (e.g., Th2) when the reduced-power timer satisfies the second threshold without the memory system receiving a command targeting the rank, and/or may include decreasing the second threshold when a command targeting the rank is received prior to the reduced-power timer satisfying the second threshold.

More particularly, in some implementations, after transitioning the rank to the reduced power state and/or entering the rank into a self-refresh mode (as described above in connection with reference number 802), the example 900 may include determining whether an activation trigger has occurred for the rank, which may be one of the a reduced-power timer satisfying the second threshold (e.g., Th2) or the memory system receiving a command targeting the rank (as described above in connection with reference number 410). In this implementation, and as indicated by reference number 902, when the reduced-power timer satisfies the second threshold prior to the memory system receiving a command targeting the rank (indicative that the second threshold may be shorter than an optimal duration from a power-savings perspective), the second threshold may be increased prior to performing the self-refresh power down exit (as described above in connection with reference number 806). In this way, during a subsequent entry of the rank into the self-refresh power down state, the second threshold will have a longer duration, thereby increasing the power-savings benefits during workloads with relatively few commands targeting the rank.

On the hand, when a command is received targeting the rank prior to the reduced-power timer satisfying the second threshold (indicative that the second threshold may be longer than an optimal duration from a latency and/or performance perspective), the second threshold may be decreased prior to performing the self-refresh power down exit (as described above in connection with reference number 806). More particularly, as indicated by reference number 904, the example 900 may include determining whether the second threshold is already at a minimum configured value. If the second threshold is already at the minimum configured value (indicated by the arrow labeled “Y” in connection with operations shown by reference number 904), the example 900 may include simply performing the self-refresh power down exit in a similar manner as described above in connection with reference number 806. However, if the second threshold is larger than the minimum configured value (indicated by the arrow labeled “N” in connection with operations shown by reference number 904), the example 900 may include decreasing the second threshold, as indicated by reference number 906, prior to performing the self-refresh power down exit. In this way, during a subsequent entry of the rank into the self-refresh power down state, the second threshold will have a shorter duration, thereby decreasing latency and/or increasing memory device performance for workloads having many commands targeting the rank.

In some implementations, a memory system implementing example 900 may receive, from a host system, an indication of one or more parameters enabling the operations described above, such as via one or more registers associated with the memory system. For example, in some implementations, the memory system may receive an indication of the first threshold (e.g., Th1), which may be a fixed value, an initial value of the second threshold (e.g., Th2), and/or minimum value of the second threshold (which may have no maximum value in this implementation because the rank may be switched to the self-refresh mode in the reduced power state, as described above). Additionally, or alternatively, the memory system may receive an indication of an activation trigger for exiting the reduced power state (as described above in connection with reference number 410), such as whether the rank should be transitioned to the active or idle state upon the reduced-power timer satisfying the threshold and/or upon the memory system receiving a command targeting the rank. Additionally, or alternatively, the memory system may receive an indication of conditions to be followed after command completion (as described above in connection with reference number 406), such as whether the rank should be transitioned to the reduced power state immediately upon command competition or whether the memory system should wait for a configured wait period (e.g., Y ns/μs) after command completion to transition the rank to the reduced power state, as described above.

As indicated above, FIG. 9 is provided as an example. Other examples may differ from what is described with regard to FIG. 9.

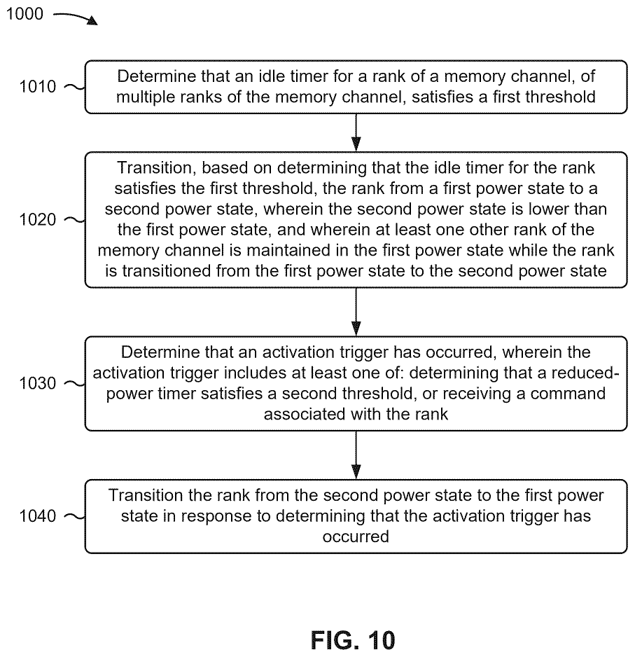

FIG. 10 is a flowchart of an example method 1000 associated with per-rank power management operations for a multi-rank memory system. In some implementations, a memory controller (e.g., the memory system controller 115, local controller 125, and/or memory controller 210) may perform or may be configured to perform the method 1000. In some implementations, another device or a group of devices separate from or including the memory controller (e.g., memory system 110 and/or Multi-rank memory system 200) may perform or may be configured to perform the method 1000. Additionally, or alternatively, one or more components of the memory controller (e.g., a power state machine and/or a power state engine within the memory system controller 115, local controller 125, and/or memory controller 210) may perform or may be configured to perform the method 1000. Thus, means for performing the method 1000 may include the memory controller and/or one or more components of the memory controller. Additionally, or alternatively, a non-transitory computer-readable medium may store one or more instructions that, when executed by the memory controller, cause the memory controller to perform the method 1000.

As shown in FIG. 10, the method 1000 may include determining that an idle timer for a rank of a memory channel, of multiple ranks of the memory channel, satisfies a first threshold (block 1010). For example, the multi-rank memory system 200 or a similar memory system may determine that idle timer for a given rank (e.g., Rank X) of the memory system satisfies a first threshold (e.g., Th1), as described above in connection with reference number 408.

As further shown in FIG. 10, the method 1000 may include transitioning, based on determining that the idle timer for the rank satisfies the first threshold, the rank from a first power state to a second power state, wherein the second power state is lower than the first power state, and wherein at least one other rank of the memory channel is maintained in the first power state while the rank is transitioned from the first power state to the second power state (block 1020). For example, the multi-rank memory system 200 or a similar memory system may transition the rank (e.g., Rank X) from an active or idle state (e.g., AIS 302) to a reduced power state, such as the RPS 304 and/or the reduced power state 409.

As further shown in FIG. 10, the method 1000 may include determining that an activation trigger has occurred, wherein the activation trigger includes at least one of: determining, by the memory controller, that a reduced-power timer satisfies a second threshold, or receiving, by the memory controller, a command associated with the rank (block 1030). For example, the multi-rank memory system 200 or a similar memory system may determine that a reduced-power timer associated with the rank (e.g., Rank X) satisfies a second threshold (e.g., Th2) and/or that a command has been received that targets the rank, as described above in connection with reference number 410.

As further shown in FIG. 10, the method 1000 may include transitioning the rank from the second power state to the first power state in response to determining that the activation trigger has occurred (block 1040). For example, the multi-rank memory system 200 or a similar memory system may transition the rank back to the active or idle state (e.g., AIS 302) based on the reduced-power timer satisfying the second threshold (e.g., Th2) and/or based on receiving a command that targets the rank, as described above in connection with reference number 410.

The method 1000 may include additional aspects, such as any single aspect or any combination of aspects described below and/or described in connection with one or more other methods or operations described elsewhere herein.

In a first aspect, the method 1000 includes receiving, from a host system via one or more registers associated with the memory system, an indication of at least one of the first threshold or the second threshold. For example, as described above in connection with FIGS. 4 and 6-9, the multi-rank memory system 200 or a similar memory system may receive an indication of various configuration parameters enabling the per-rank power management operations described herein, such as an indication of the first threshold (e.g., Th1) and/or the second threshold (e.g., Th2), among other examples.

In a second aspect, alone or in combination with the first aspect, the method 1000 includes one of initializing the idle timer based on completion of a last-received command, or initializing the idle timer based on a wait period elapsing. For example, as described above in connection with reference number 406, the multi-rank memory system 200 or a similar memory system may be configured to initialize the idle timer based on completion of a last-received command or else to initialize the idle timer based on a wait period (e.g., Y ns/μs) elapsing, among other examples.

In a third aspect, alone or in combination with one or more of the first and second aspects, the method 1000 includes performing, by the memory controller, at least one of a refresh operation associated with the rank prior to transitioning the rank from the first power state to the second power state, or the refresh operation associated with the rank after transitioning the rank from the second power state to the first power state. For example, as described above in connection with FIG. 6, the multi-rank memory system 200 or a similar memory system may be configured to perform a PB refresh operation on the rank (e.g., Rank X) prior to transitioning the rank from the active or idle state to the reduced power state (as described above in connection with reference number 602) and/or perform a PB refresh operation on the rank after transitioning the rank from the reduced power state to the active or idle state (as described above in connection with reference number 610).

In a fourth aspect, alone or in combination with one or more of the first through third aspects, the method 1000 includes switching, prior to transitioning the rank from the first power state to the second power state, the rank from one of a per-bank refresh pool or an all-bank refresh pool to the other one of the per-bank refresh pool or the all-bank refresh pool, and switching, after transitioning the rank from the second power state to the first power state, the rank from the other one of the per-bank refresh pool or the all-bank refresh pool to the one of the per-bank refresh pool or the all-bank refresh pool. For example, as described above in connection with FIG. 7, the multi-rank memory system 200 or a similar memory system may be configured to switch the rank (e.g., Rank X) from a PB refresh pool (e.g., PB refresh pool 501) to an AB refresh pool (e.g., AB refresh pool 502) prior to transitioning the rank from the active or idle state to the reduced power state (as described above in connection with reference number 702) and/or switch the rank from the AB refresh pool back to the PB refresh pool after transitioning the rank from the reduced power state to the active or idle state (as described above in connection with reference number 704).

In a fifth aspect, alone or in combination with one or more of the first through fourth aspects, the method 1000 includes entering, based on transitioning the rank from the first power state to the second power state, the rank into a self-refresh mode, and exiting, based on transitioning the rank from the second power state to the first power state, the rank from the self-refresh mode. For example, as described above in connection with FIG. 8, the multi-rank memory system 200 or a similar memory system may be configured to enter the rank (e.g., Rank X) into a self-refresh mode based on transitioning the rank from the active or idle state to the reduced power state (as described above in connection with reference number 802) and/or exit the rank from the self-refresh mode based on transitioning the rank from the reduced power state to the active or idle state (as described above in connection with reference number 806).

In a sixth aspect, alone or in combination with one or more of the first through fifth aspects, the activation trigger includes determining that the reduced-power timer satisfies the second threshold, and wherein the method further comprises increasing the second threshold based on determining that the reduced-power timer satisfies the second threshold. For example, as described above in connection with FIG. 9, the multi-rank memory system 200 or a similar memory system may be configured to increase the second threshold (e.g., Th2) based on the reduced power timer satisfying the second threshold prior to the memory system receiving a command targeting the rank (as described above in connection with reference number 902).

In a seventh aspect, alone or in combination with one or more of the first through sixth aspects, the activation trigger includes receiving the command associated with the rank, and wherein the method further comprises decreasing the second threshold based on receiving the command associated with the rank. For example, as described above in connection with FIG. 9, the multi-rank memory system 200 or a similar memory system may be configured to decrease the second threshold (e.g., Th2) based on the memory system receiving a command targeting the rank prior to the reduced power timer satisfying the second threshold (as described above in connection with reference numbers 904 and 906).

Although FIG. 10 shows example blocks of a method 1000, in some implementations, the method 1000 may include additional blocks, fewer blocks, different blocks, or differently arranged blocks than those depicted in FIG. 10. Additionally, or alternatively, two or more of the blocks of the method 1000 may be performed in parallel. The method 1000 is an example of one method that may be performed by one or more devices described herein. These one or more devices may perform or may be configured to perform one or more other methods based on operations described herein.

In some implementations, a method includes determining, by a memory controller of a memory system, that an idle timer for a rank of a memory channel, of multiple ranks of the memory channel, satisfies a first threshold; transitioning, by the memory controller and based on determining that the idle timer for the rank satisfies the first threshold, the rank from a first power state to a second power state, wherein the second power state is lower than the first power state, and wherein at least one other rank of the memory channel is maintained in the first power state while the rank is transitioned from the first power state to the second power state ; determining, by the memory controller, that an activation trigger has occurred, wherein the activation trigger includes at least one of: determining, by the memory controller, that a reduced-power timer satisfies a second threshold, or receiving, by the memory controller, a command associated with the rank; and transitioning, by the memory controller, the rank from the second power state to the first power state in response to determining that the activation trigger has occurred.

In some implementations, a memory system includes one or more components configured to: determine that an idle timer for a rank of a memory channel, of multiple ranks of the memory channel, satisfies a first threshold; transition, based on determining that the idle timer for the rank satisfies the first threshold, the rank from a first power state to a second power state, wherein the second power state is lower than the first power state, and wherein at least one other rank of the memory channel is maintained in the first power state while the rank is transitioned from the first power state to the second power state; determine that an activation trigger has occurred, wherein the activation trigger includes at least one of: a determination that a reduced-power timer satisfies a second threshold, or reception of a command associated with the rank; and transition the rank from the second power state to the first power state in response to determining that the activation trigger has occurred.

In some implementations, a multi-rank memory system includes multiple memory components organized into multiple memory channels, each memory channel associated with multiple ranks; and a memory controller operatively connected to the multiple memory components, wherein the memory controller is configured to: determine that an idle timer for a rank of a memory channel, of the multiple ranks of the memory channel, satisfies a first threshold; transition, based on determining that the idle timer for the rank satisfies the first threshold, the rank from a first power state to a second power state, wherein the second power state is lower than the first power state, and wherein at least one other rank of the memory channel is maintained in the first power state while the rank is transitioned from the first power state to the second power state; determine that an activation trigger has occurred, wherein the activation trigger includes at least one of: a determination that a reduced-power timer satisfies a second threshold, or reception of a command associated with the rank; and transition the rank from the second power state to the first power state in response to determining that the activation trigger has occurred.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the term “substantially” means “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
determining, by a memory controller of a memory system, that an idle timer for a rank of a memory channel, of multiple ranks of the memory channel, satisfies a first threshold;
transitioning, by the memory controller and based on determining that the idle timer for the rank satisfies the first threshold, the rank from a first power state to a second power state,
wherein the second power state is lower than the first power state, and
wherein at least one other rank of the memory channel is maintained in the first power state while the rank is transitioned from the first power state to the second power state;
determining, by the memory controller, that an activation trigger has occurred,
wherein the activation trigger includes at least one of:
determining, by the memory controller, that a reduced-power timer satisfies a second threshold, or
receiving, by the memory controller, a command associated with the rank; and
transitioning, by the memory controller, the rank from the second power state to the first power state in response to determining that the activation trigger has occurred.

2. The method of claim 1, further comprising receiving, from a host system via one or more registers associated with the memory system, an indication of at least one of the first threshold or the second threshold.

3. The method of claim 1, further comprising one of:
initializing, by the memory controller, the idle timer based on completion of a last-received command; or
initializing, by the memory controller, the idle timer based on a wait period elapsing.

4. The method of claim 1, further comprising performing, by the memory controller, at least one of:
a refresh operation associated with the rank prior to transitioning the rank from the first power state to the second power state, or
the refresh operation associated with the rank after transitioning the rank from the second power state to the first power state.

5. The method of claim 1, further comprising:
switching, prior to transitioning the rank from the first power state to the second power state, the rank from one of a per-bank refresh pool or an all-bank refresh pool to the other one of the per-bank refresh pool or the all-bank refresh pool; and
switching, after transitioning the rank from the second power state to the first power state, the rank from the other one of the per-bank refresh pool or the all-bank refresh pool to the one of the per-bank refresh pool or the all-bank refresh pool.

6. The method of claim 1, further comprising:
entering, based on transitioning the rank from the first power state to the second power state, the rank into a self-refresh mode; and
exiting, based on transitioning the rank from the second power state to the first power state, the rank from the self-refresh mode.

7. The method of claim 1, wherein the activation trigger includes determining that the reduced-power timer satisfies the second threshold, and
wherein the method further comprises increasing the second threshold based on determining that the reduced-power timer satisfies the second threshold.

8. The method of claim 1, wherein the activation trigger includes receiving the command associated with the rank, and
wherein the method further comprises decreasing the second threshold based on receiving the command associated with the rank.

9. A memory system, comprising:
one or more components configured to:
determine that an idle timer for a rank of a memory channel, of multiple ranks of the memory channel, satisfies a first threshold;
transition, based on determining that the idle timer for the rank satisfies the first threshold, the rank from a first power state to a second power state,
wherein the second power state is lower than the first power state, and
wherein at least one other rank of the memory channel is maintained in the first power state while the rank is transitioned from the first power state to the second power state;
determine that an activation trigger has occurred,
wherein the activation trigger includes at least one of:
a determination that a reduced-power timer satisfies a second threshold, or
reception of a command associated with the rank; and
transition the rank from the second power state to the first power state in response to determining that the activation trigger has occurred.

10. The memory system of claim 9, wherein the one or more components are further configured to receive, from a host system via one or more registers, an indication of at least one of the first threshold or the second threshold.

11. The memory system of claim 9, wherein the one or more components are further configured to one of:
initialize the idle timer immediately based on completion of a last-received command; or
initialize the idle timer based on a wait period elapsing.

12. The memory system of claim 9, wherein the one or more components are further configured to perform at least one of:
a refresh operation associated with the rank prior to transitioning the rank from the first power state to the second power state, or
the refresh operation associated with the rank after transitioning the rank from the second power state to the first power state.

13. The memory system of claim 9, wherein the one or more components are further configured to:
switch, prior to transitioning the rank from the first power state to the second power state, the rank from one of a per-bank refresh pool or an all-bank refresh pool to the other one of the per-bank refresh pool or the all-bank refresh pool; and
switch, after transitioning the rank from the second power state to the first power state, the rank from the other one of the per-bank refresh pool or the all-bank refresh pool to the one of the per-bank refresh pool or the all-bank refresh pool.

14. The memory system of claim 9, wherein the one or more components are further configured to:
enter, based on transitioning the rank from the first power state to the second power state, the rank into a self-refresh mode; and
exit, based on transitioning the rank from the second power state to the first power state, the rank from the self-refresh mode.

15. The memory system of claim 9, wherein the activation trigger includes the determination that the reduced-power timer satisfies the second threshold, and p1 wherein the one or more components are further configured to increase the second threshold based on the determination that the reduced-power timer satisfies the second threshold.

16. The memory system of claim 9, wherein the activation trigger includes reception of the command associated with the rank, and
wherein the one or more components are further configured to decrease the second threshold based on the reception of the command associated with the rank.

17. A multi-rank memory system, comprising:
multiple memory components organized into multiple memory channels, each memory channel associated with multiple ranks; and
a memory controller operatively connected to the multiple memory components, wherein the memory controller is configured to:
determine that an idle timer for a rank of a memory channel, of the multiple ranks of the memory channel, satisfies a first threshold;
transition, based on determining that the idle timer for the rank satisfies the first threshold, the rank from a first power state to a second power state,
wherein the second power state is lower than the first power state, and
wherein at least one other rank of the memory channel is maintained in the first power state while the rank is transitioned from the first power state to the second power state;
determine that an activation trigger has occurred,
wherein the activation trigger includes at least one of:
a determination that a reduced-power timer satisfies a second threshold, or
reception of a command associated with the rank; and
transition the rank from the second power state to the first power state in response to determining that the activation trigger has occurred.

18. The multi-rank memory system of claim 17, wherein the memory controller is further configured to receive, from a host system via one or more registers, an indication of at least one of the first threshold or the second threshold.

19. The multi-rank memory system of claim 17, wherein the memory controller is further configured to one of:
initialize the idle timer based on completion of a last-received command; or initialize the idle timer based on a wait period elapsing.

20. The multi-rank memory system of claim 17, wherein the memory controller is further configured to perform at least one of:
a refresh operation associated with the rank prior to transitioning the rank from the first power state to the second power state, or
the refresh operation associated with the rank after transitioning the rank from the second power state to the first power state.

21. The multi-rank memory system of claim 17, wherein the memory controller is further configured to:
switch, prior to transitioning the rank from the first power state to the second power state, the rank from one of a per-bank refresh pool or an all-bank refresh pool to the other one of the per-bank refresh pool or the all-bank refresh pool; and
switch, after transitioning the rank from the second power state to the first power state, the rank from the other one of the per-bank refresh pool or the all-bank refresh pool to the one of the per-bank refresh pool or the all-bank refresh pool.

22. The multi-rank memory system of claim 17, wherein the memory controller is further configured to:
enter, based on transitioning the rank from the first power state to the second power state, the rank into a self-refresh mode; and
exit, based on transitioning the rank from the second power state to the first power state, the rank from the self-refresh mode.

23. The multi-rank memory system of claim 17, wherein the activation trigger includes the determination that the reduced-power timer satisfies the second threshold, and
wherein the memory controller is further configured to increase the second threshold based on the determination that the reduced-power timer satisfies the second threshold.

24. The multi-rank memory system of claim 17, wherein the activation trigger includes reception of the command associated with the rank, and
wherein the memory controller is further configured to decrease the second threshold based on the reception of the command associated with the rank.
